(19) United States
(12) Patent Application Publication
(10) Pub. No.: US 2012/0059961 A1
(43) Pub. Date: Mar. 8, 2012

(54) SYSTEM AND METHOD FOR SHARING MEMORY

(75) Inventors: Steven Thomas Hershberger, Hamilton, IN (US); Ronald Douglas Johnson, Hamilton, IN (US)

(73) Assignee: THOMSON LICENSING a Corporation

(21) Appl. No.: 13/319,598

(22) PCT Filed: Apr. 23, 2010
(86) PCT No.: PCT/US2010/032163

§ 371 Date: Nov. 9, 2011

Related U.S. Application Data
(60) Provisional application No. 61/178,683, filed on May 15, 2009.

(51) Int. Cl. G06F 13/00

(52) U.S. Cl. 710/107

(57) ABSTRACT

A system and method for interfacing multiple SoCs (System on a Chip) to a single, shared memory device are provided. The system and method of the present disclosure provides for controlling the downloading of operating code to two or more SoC controller circuits sharing a memory containing the operating code and a common communications bus, where each controller is a master controller of the communications bus in normal operation. The system and method involves sequentially controlling access of each of the controller circuits to the communications bus to allow each device to separately download the common operating code. The system and method utilize a separate initializing circuit or device along with chaining the controllers together in a series such that each controller be held in a reset state to prevent communications bus access until the previous controller in the chain has completed its code download.

### REFERENCE TO RELATED PROVISIONAL APPLICATION

This application claims priority from provisional application No. 61/178,683, entitled “System and Method for Sharing Memory between Master Controller Integrated Circuits” filed on May 15, 2009.

### TECHNICAL FIELD OF THE INVENTION

The present disclosure generally relates to integrated circuits and memory devices, and more particularly, to a system and method for interfacing multiple SoCs (System on a Chip) to a single, shared memory device.

### BACKGROUND OF THE INVENTION

Today, it is not uncommon for electronic designs used in devices, such as video head end signal distribution systems and video set-top box controllers, to include multiple complex integrated circuits known as SoCs (System on a Chip). An SoC typically includes a set of functions including signal modulation or demodulation, signal encoding or decoding, and signal compression or decompression as found in a signal processing chain. An SoC also typically includes a programmable controller or microprocessor for controlling each of these functions as well as many external interface functions necessary to operate the device.

The programming code for an SoC may often be stored in an external memory device such as a flash memory device. An SoC typically downloads a software image at power-on or reset using a serial peripheral interface (SPI) bus. During this operation, the SoC acts as an SPI master and expects the flash memory device to respond as an SPI slave. Because each SoC can execute the same code image, using a single flash memory device saves printed circuit board space, bill of material cost, and manufacturing cost. However, conflicts in signaling will arise if multiple SoCs try to access the shared memory device at the same time. Because each SoC may perform autonomously, a separate memory may be connected to each SoC. However, this arrangement is inefficient if the same code image is to be loaded into each SoC in a multiple SoC device. It is desirable to have a system a method that overcomes the problems of interfacing multiple master controller So to a single, shared memory device.

### SUMMARY

A system and method for interfacing a plurality of programmable controllers to a single, shared memory is provided, the method including storing a set of instruction code used by the plurality of programmable controllers, downloading the set of instruction code to a first programmable controller over a common communications bus, and downloading the set of instruction code to the second programmable controller over the common communications bus when the downloading of the set of instruction code to the first programmable controller is completed.

### BRIEF DESCRIPTION OF THE DRAWINGS

These and other aspects, features, and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary video controller device in accordance with the present disclosure;

FIG. 2 is a block diagram of an exemplary system for interfacing multiple SoCs (System on a Chip) to a single, shared memory device in accordance with the present disclosure;

FIG. 3 is a flowchart of an exemplary method for interfacing multiple SoCs (System on a Chip) to a single, shared memory device in accordance with the present disclosure; and

FIG. 4 illustrates an exemplary signal timing diagram in accordance with an embodiment of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGs. may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The disclosed embodiments are directed at the problem of interfacing more than one System on a Chip (SoC) integrated circuit to a shared memory. More specifically, the embodiments address the problem of multiple SoCs booting from a single memory device, such as an SPI bus flash memory, when each master-only SoC is connected using a single communications bus, such as an SPI bus.

The system and method of the present disclosure provide for controlling the downloading of operating code to two or more “System on a Chip” (SoC) controller circuits sharing a common memory and common communications bus, where each controller is a master controller of the communications bus in normal operation. The present disclosure involves sequentially controlling access of each of the SoC controller circuits to the communications bus to allow each device to separately download the common operating code. The present disclosure may utilize a separate initializing circuit or device along with chaining the controllers together in a series and may require that each controller be held in a reset state to prevent communications bus access until the previous controller in the chain has completed its code download.

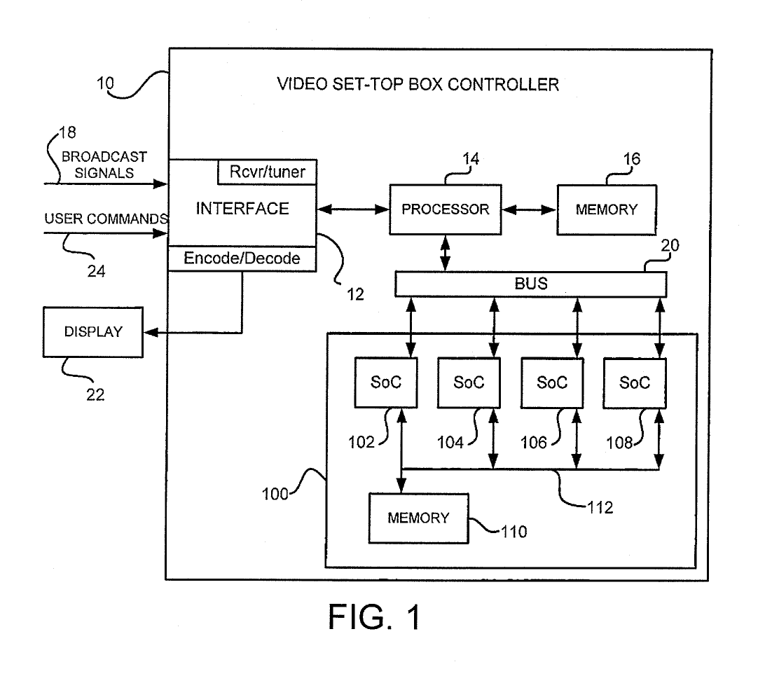

Referring now to FIG. 1, a block-diagram of an embodiment of a video controller device 10 according to an aspect of the present disclosure is shown. Device 10 may be integrated into a display device such as a digital television, or a set-top unit or box, for example. In one embodiment, video controller device 10 is a personal video recorder (PVR). In another embodiment, video controller device 10 is a digital video recorder (DVR). In a further embodiment, the video controller device 10 is part of a video head end signal distribution device. It should be appreciated that video controller device 10 may be any electronic device for use in playing and/or recording programs, and is not intended to be limited to the examples given above.

Device 10 includes receiver functionality for receiving multimedia program content. Device 10 includes an interface 12 for receiving an input signal. Interface 12 includes a receiver/tuner and provides an output signal containing multimedia program content data to processor 14 and/or memory 16. Such data may be in the form of a broadcast signal 18 in either analog or digital format. Where the broadcast signal is an analog signal, the analog signal is converted to a digital signal. In one embodiment, the broadcast signal is an MPEG data stream received over a cable from a cable television provider. In another embodiment, the broadcast signal is received from a satellite broadcast by a satellite television provider. In yet another embodiment, the broadcast signal is transmitted over the airways from a broadcast tower by a television broadcaster (e.g., a television station). It should be appreciated that the broadcast signal can be any signal for rendering on an audio/video display device, and is not intended to be limited by the aforementioned embodiments.

As shown in FIG. 1, video controller device 10 further includes bus 20 for communicating information, processor 14 coupled with bus 20 for processing information and instructions and memory 16 (e.g., volatile or non-volatile memory, including random access memory, static RAM, dynamic RAM, read only memory, programmable ROM, flash memory, EPROM, EEPROM, etc.) coupled with processor 14 for storing information and instructions for processor 14. It should be appreciated that a data storage device may be provided for storing program content data and can be any memory or storage medium for storing digital data, such as a magnetic or optical disk and disk drive.

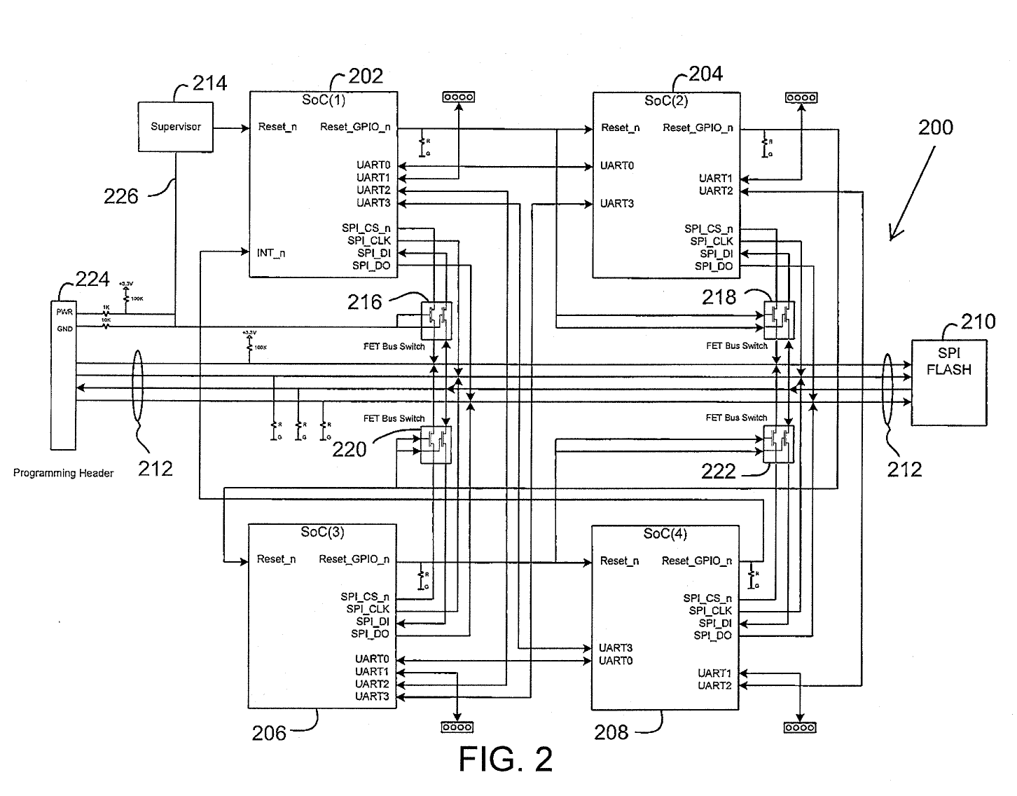

In an exemplary configuration, video controller device 10 comprises a system 100 for decoding and encoding video signals configured to receive broadcast signals 18 containing program content and digitize an analog signal into a digital format for playback and/or storage. In this embodiment, the system 100 includes at least four SoCs 102-104 coupled to shared memory 110 via bus 112. Each of the SoCs sequentially access the memory 110 via bus 112 when operating code is needed at startup or when the system or device is rebooted. The operation of system 100 will be described in more detail below with reference to FIGS. 2-4, where system 100 is represented in other embodiments as system 200. It is to be appreciated that each SoC is also separately coupled to bus 20 which may be any communication bus to exchange data between processor 14 and the SoCs (i.e., bus 20 is separate and not connected to bus 112). In one embodiment, bus 20 is an Ethernet connection.

Device 10 may further include a power supply and other ancillary components (not shown) for facilitating recording and playback processing. The video controller device 10 also includes a digital video encoder/decoder as part of interface 12 for receiving a recorded program or processed data from system 100 in a digital format and decoding the signal for rendering on an audio/video display device 22. The audio/video display device 22 may be a television, a PVR display screen, or other such display. Alternatively, the digital video encoder/decoder in interface 12 may provide the digital video signal as part of a communications system for distribution to multiple display devices.

The video controller device 10 further operates to receive user commands 24 via an interface such as interface 12. User commands may emanate from a remote control communicatively coupled to the device by a wireless connection, or may be input manually. It should be appreciated that user commands may be received in response to interaction with a graphical user interface rendered on an audio/video display device 22 which may be integrated with device 10 or externally coupled thereto.

FIG. 2 shows an embodiment of a system 200 used for decoding and encoding video signals. System 200 may be included as part of a signal receiving system such as the video controller device 10 described in FIG. 1. The system 200 includes four SoCs, labeled SOC(1) 202, SoC(2) 204, SoC(3) 206, and SoC(4) 208. A memory device 210, e.g., SPI flash, is connected to each SoC through a common SPI bus 212. Each SoC has at least four signal lines coupled to the common SPI bus 212, namely, a chip select signal SPI_CS_n, a clock signal SPI_CLK, a digital input signal SPI_DI and a digital output signal SPI_DO. A supervisor IC 214 is connected to SoC(1) 202 and is used for initialization. To allow each SoC to be programmed from the shared SPI flash 210, each SoC accesses the memory device in a sequence, with the prior SoC in the sequence controlling the initiation of the access of the current SoC using its reset input signal. The reset signal supplied to the first SoC (e.g. SOC(1) 202) in the sequence will be controlled normally by a supervisor IC 214 that monitors the status of a system or local reset, a startup condition, or a measurement of the voltage supplies for either system 200 or a main system device, such as video controller device 10 in FIG. 1. It is to be appreciated that some form of reset control is necessary. The supervisor IC 214 provides that control and is only dependent on the voltage supply level of the system. However, the reset could be controlled from other parts of the overall system by a signal from another processor or device, e.g., processor 14 shown in FIG. 1. Programming header 224 may provide an alternative for a control of the reset of system 200 in order to autonomously read/write to the SRI flash device 210.

When the supervisor IC 214 determines the voltage supplies are within tolerance and releases the reset signal to the first SoC, the first SoC 202 will take control of the SPI bus 212 and begin downloading code from the memory device 210 while keeping an output signal active that holds the next SoC (e.g. SOC(2) 204, etc) in the sequence in reset, e.g., Reset_GPIO_n, where GPIO stands for General Purpose Input/Output. The next SoC also has an output signal that holds the next SoC in the sequence in reset, and so on to the end of the sequence.

The same reset output signal from each of the SoCs, i.e., Reset_GPIO_n, may also control a switching device, e.g., a (Field Effect Transistor) FET bus switch, shown connected into the SPI bus 212 at the interface to each SoC, i.e., FET 216, 218, 220, 222 respectively. The FET bus switches may be necessary if the SoC does not tri-state all of the SRI bus signals while being held in reset, e.g., the chip select signal SPI_CS_n and digital input signal SPI_DI. If the SoC is in reset, the FET bus switch for its SPI bus signals will be off. Once the SoC has completed downloading the software image, the SoC will change the mode of its SPI bus signals to general purpose inputs which releases the SPI bus to be used by the next SoC in the sequence. Since the SoC no longer drives the SPI bus signals, the FET bus switches on the SPI bus signals for this SoC can be left in the on position. Further, a tri-statable buffer may be used instead of a FET bus switch. However, leaving the FET bus switches in the on position simplifies the design by not having to create a separate signal that would be needed to turn off a tri-statable buffer. The elimination of a control signal is an advantage of using FET bus switches instead of tri-statable buffers.

The SoC that has completed software image download, in this case SoC(1) 202, now releases the reset signal to the next SoC, SoC(2) 204, in the sequence which turns on the FET bus switches for this SoC, i.e., FET 218, and starts the software download operation for this SoC. These same steps repeat and continue for each SoC in the sequence. When the last SoC in the sequence completes the download operation and releases the reset signal, this signal is sent back to the first SoC in the sequence which indicates all SoCs have completed the download operation and are running the application. The first SoC, i.e., SoC(1) 202 can now re-attach to the flash memory 210 using the SPI bus 212 because all other SoCs in the chain will no longer be driving the SP1 bus 212. The final release and turnover of the SPI bus 212 will allow the flash memory 210 to be used for non-volatile storage for the system with SoC(1) 202 as the interface device for all of the SoCs.

It is important to note that although system 200 in FIG. 2, as well as system 100 in FIG. 1, includes a set of four SOCs, the structure may be adapted to include a different numbers of SOCs. For instance, two SOCs may be included and programmed with a downloadable code image over a common communications bus from a shared memory. Additionally, more than four SOCs may be included and connected through a common communications to a shared memory containing the downloadable code image. Further, although the most efficient use of memory will occur when downloading the identical software code image to each SOC, the structure may also advantageously be used when the software code image for each SOC contains differences. For instance, a separate file or code portion may be added to an otherwise identical code image for each SOC, the file or code portion containing the differences for each SOC, such as a change to a starting address for the instruction code.

As described in FIG. 1 and FIG. 2, a memory, such as memory 110 or memory 210, may be shared between multiple controllers or SOCs. It is important to note that all or a portion of the memory may be shared and common between one or more of the controllers or SOCs. Further, the implementation of the memory may include several possible embodiments, such as a single memory device or, alternatively, more than one memory circuit connected together to form a shared or common memory. Still further, the memory may be included with other circuitry, such as portions of bus communications circuitry, in a larger circuit. Finally, the memory may utilize any current storage technology suitable for storing instruction code including, but not limited to, static random access memory (SRAM), read only memory (ROM), and hard disk drive.

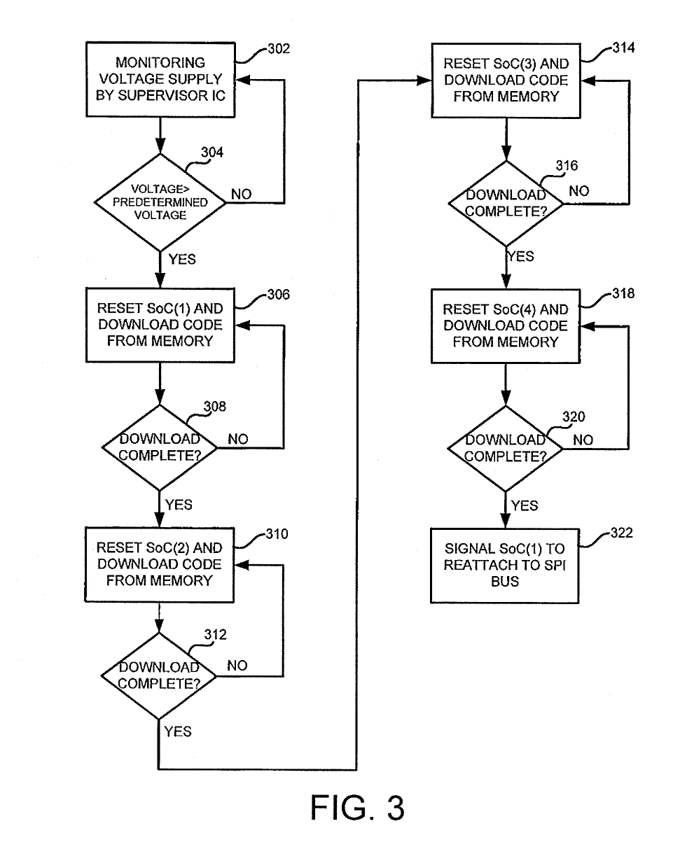

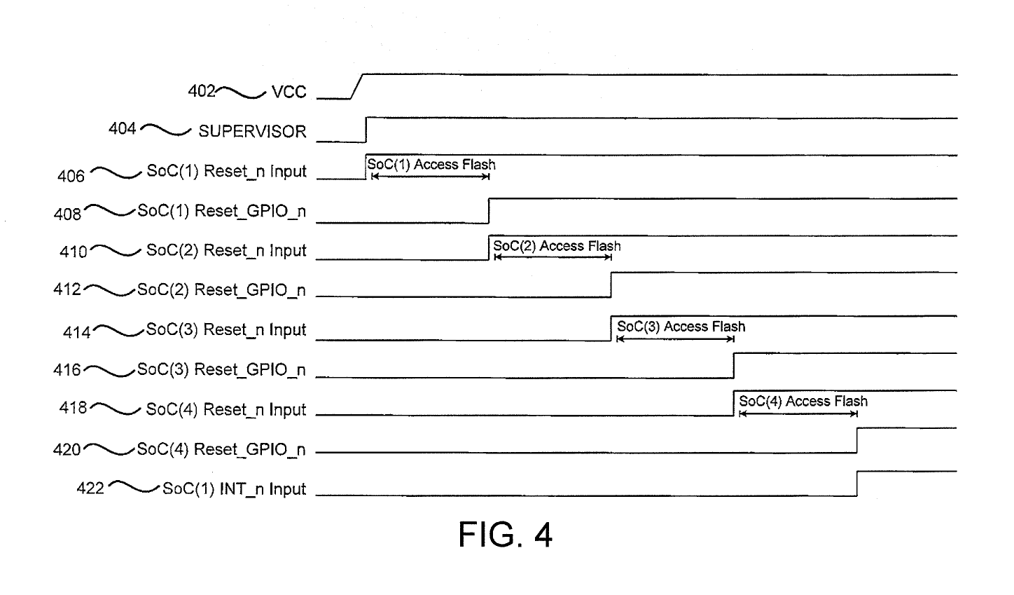

Referring to FIGS. 3-4, a method for interfacing multiple SoCs (System on a Chip) to a single, shared memory device in accordance with the embodiments shown in FIGS. 1 and 2 will be described where FIG. 3 is a flowchart for explaining an exemplary method and FIG. 4 illustrates an exemplary signal timing diagram.

Initially, at step 302, the system 200 is powered up and will to attempt startup or bootup and the supervisor IC 214 monitors the power supply supplying various voltages to the system 200. At step 304, the supervisor IC 214 determines if the supplied voltage is within a predetermined tolerance, e.g., if the supplied voltage is greater than a predetermined voltage. If the supplied voltage is not within the predetermined tolerance, the supervisor IC 214 will continue to monitor the supply voltages. Otherwise, the supervisor IC 214 determines that the supply voltage is good, e.g., VCC 402 is high as shown in FIG. 4, and the supervisor IC 214 sets its output signal high, e.g., SUPERVISOR signal 404 is high as shown in FIG. 4. The output of the supervisor IC 214 is coupled to the reset input (Reset_n) 406 of SoC(1) 202, which then goes high and enables SoC(1) 202 to access the memory 210 and download the necessary code over the communication bus 212, at step 306. While SoC(1) 202 is accessing the SPI flash 210, an output of SoC(1) 202, i.e., Reset_GPIO_n 408, is holding the reset input of the next SoC in a low state to prevent the next SoC, e.g., SoC(2) 204, from accessing the memory device 210.

Next, at step 308, SoC(1) 202 will determine if the download of code is complete and, if not, will continue downloading code. In one embodiment, the SoC will determine that the download is complete by executing the downloaded code. Near the beginning of this executing code will be instructions to stop driving the SPI bus interface and to release the reset of the next SoC. If, at step 308, SoC(1) 202 has determined that the download is complete, SoC(1) 202 will set its output signal, i.e., Reset_GPIO_n 408, to a high state which subsequently causes the reset input (Reset_n) 410 of SoC(2) 204 to go to a high state. When the reset input (Reset_n) 410 of SoC(2) 204 transitions to a high state, SoC(2) 204 will come out of reset, access the memory device 210 and download the necessary code form the memory device 210, step 310.

The method will continue until the remaining SoCs have been downloaded. For example, in step 312, SoC(2) 204 will determine if the download of code is complete and, if not, will continue downloading code. If, at step 312, SoC(2) 204 has determined that the download is complete, SoC(2) 204 will set its output signal, i.e., Reset_GPIO_n 412, to a high state which subsequently causes the reset input (Reset_n) 414 of SoC(3) 206 to go to a high state. With the reset input (Reset_n) 414 of SoC(3) 206 in a high state, SoC(3) 206 will come out of reset, access the memory device 210 and download the necessary code form the memory device 210, step 314.

At steps 316-320, the method proceeds to download code for the remaining SoC, i.e., SoC(4) 208 when Reset_GPIO_n 416 and reset input (Reset_n) 418 go to a high state. If at step 320, it has been determined that the downloading of code is complete for the last SoC, the output signal, i.e., Reset_GPIO_n 420, of the last SoC is fed back to an input, e.g., SoC(1) INT_n 422, of the first SoC, at step 322. The first SoC will be programmed to reattach to the communication bus 212, e.g., the SPI bus, upon the input signal going to a high state.

It is important to note that although the steps in process 300 describe programming a set of four SOCs, the steps may be adapted to programming different numbers of SOCs. For instance, two SOCs may be programmed by eliminating steps 314-320. Additionally, more than four SOCs may be programmed using process 300 by adding steps similar to steps 314-316 for each additional SOC.

It may be important for the first SoC, i.e., SoC(1) 202, to know about the completion of the download operations of the other SoCs because this first device may become the single main controller and also the single point of access to the memory device during the normal operation of the design, i.e., SoC(1) 202 may become the master controller. If one of the other SoCs needs read or write access to the memory device, a command/data structure will be communicated between this SoC and the first SoC using, for example, a standard serial communication bus. In one embodiment, the serial communications among the SoCs will be conducted over a UART channel, e.g., UART0, UART1, UART2 and UART3 as shown on SoC(1) 202. Using one SoC as the single point of access to the memory device will eliminate the need for all of the SoCs to negotiate for access to the memory device, simplifying communication between SoCs and eliminating any conflicts on the memory device communication bus 212. Also, if any SoC experiences a soft reset, the last SoC's reset output signal, i.e., Reset_GPIO_n, will become active which will indicate to the first SoC to initiate a complete reset of the system.

Additionally, the need for programming a memory device for system with multiple master SOCs, such as system 200, with the memory device and SOCs in-circuit using a programming tool can be accomplished by the programming tool indicating its presence using an input to the system's supervisor IC, via line 226, and to the FET bus switches on the first SoC in the sequence. This programming tool could be connected to the system 200 through the programming header 224. When the supervisor IC 214 gets a signal from the programming tool, the first SoC will be held in reset which will hold the next SoC in reset and so on to the end of the sequence. Since all the SoCs are being held in reset and the programming tool has turned off the FET bus switches for the first SoC, the tool can now program the memory device without conflict.

The embodiment in FIG. 2 describes a system for decoding and encoding video signals. It is important to note that the aspects described in FIG. 2 may apply equally to other systems involving multiple controllers or SoCs sharing a common memory, Further, FIG. 2 describes an embodiment using four SoCs. The aspects described in FIG. 2 may apply equally to embodiments involving more or fewer SoCs sharing a common memory.

A system and method are provided that enable multiple SoCs (System on a Chip) to download code at device startup or bootup from a single SPI flash memory device, and then share this single memory device for non-volatile storage for all SoCs. The system and method of the present disclosure is directed at controlling the downloading of operating code to two or more “System on a Chip” (SoC) controller circuits sharing a single, common memory and common communications bus, where each controller is a master controller of the communications bus in normal operation. The present disclosure involves sequentially controlling access of each of the SoC controller circuits to the communications bus to allow each device to separately download the common operating code. The present disclosure may utilize a separate initializing circuit or device along with chaining the controllers together in a series and may require that each controller be held in a reset state to prevent communications bus access until the previous controller in the chain has completed its code download. The potential for each SoC's inability to completely turn off its SP1 pins may be addressed by including switches, such as FET switches, controlled as part of the sequencing process. Finally, the system and method addresses the need to program the flash memory device in-system using an external programming tool.

According to an aspect of the present disclosure, an apparatus is provided including a memory that stores a set of instruction code used by a plurality of controllers (e.g. at least two) and provides the set of instruction code over a common communications bus, a first controller coupled to the memory, the first programmable controller downloading the set of instruction code over the common communications bus, and a second controller coupled to the memory and the first controller, the second controller downloading the set of instruction code over the common communications bus when the downloading of the set of instruction code to the first controller is completed.

In one aspect, the first controller prevents access to the communications bus by the second controller when the first controller is downloading the set of instruction code. In another aspect, the first controller prevents access by providing a signal to the second controller, the signal holding the second controller in a reset state. In a further aspect, a switching device disconnects the first controller from the communications bus when the downloading of the set of instruction code to the first controller is completed. In yet another aspect, the apparatus further includes an initializing device coupled to the first controller, wherein the initializing device provides a signal to reset the first controller to initiate the sequential downloading of the set of instruction code to the first and second controllers.

The embodiments described above describe a system and method for interfacing multiple controllers or SoCs to a single shared memory device. To allow each SoC to be programmed from the shared SPI flash, each SoC accesses the memory device in a sequence, with the prior SoC in the sequence controlling the initiation of the access of the current SoC using its reset input signal. While the application is running on each SoC, a single SoC will interface to the memory device to prevent conflicts if more than one SoC needs to read or write non-volatile parameters. The potential for each SoC's inability to completely turn off its SPI pins is addressed by including switches, such as FET switches, controlled as part of the sequencing process. Finally, the system and method addresses the need to program the flash memory device in-system using an external programming tool.

Although embodiments which incorporate the teachings of the present disclosure have been shown and described in detail herein, those skilled in the art can readily devise many other varied embodiments that still incorporate these teachings. Having described preferred embodiments of a system and method for interfacing multiple SoCs to a shared memory (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. An apparatus comprising:
a memory that stores a set of instruction code used by at least two controllers and provides the set of instruction code over a common communications bus;
a first controller coupled to the memory, the first programmable controller downloading the set of instruction code over the common communications bus; and
a second controller coupled to the memory and the first controller the second controller downloading the set of instruction code over the common communications bus when the downloading of the set of instruction code to the first controller is completed.

2. The apparatus as in claim 1, wherein the first controller prevents access to the communications bus by the second controller when the first controller is downloading the set of instruction code.

3. The apparatus as in claim 2, wherein the first controller prevents access by providing a signal to the second controller, the signal holding the second controller in a reset state.

4. The apparatus as in claim 1, wherein the first controller disconnects itself from the communications bus when the downloading of the set of instruction code to the first controller is completed.

5. The apparatus as in claim 1, wherein a switching device disconnects the first controller from the communications bus when the downloading of the set of instruction code to the first controller is completed.

6. The apparatus as in claim 5, wherein the switching device is a Field Effect Transistor (FET) bus switch.

7. The apparatus as in claim 5, wherein the switching device is a tri-statable buffer.

8. The apparatus as in claim 1, wherein the second controller provides a signal to the first controller when the downloading of the set of instruction code to the second controller is completed, the signal connecting the first controller to the communications bus.

9. The apparatus as in claim 1, further comprising an initializing device coupled to the first controller, wherein the initializing device provides a signal to reset the first controller to initiate the sequential downloading of the set of instruction code to the first and second controllers.

10. The apparatus as in claim 9, wherein the initializing device is configured to provide the signal when a supply voltage of the apparatus exceeds a predetermined voltage.

11. A method for interfacing a plurality of controllers to a single, shared memory, the method comprising:
storing a set of instruction code used by the plurality of controllers;
downloading the set of instruction code to a first controller over a common communications bus; and
downloading the set of instruction code to a second controller over the common communications bus when the downloading of the set of instruction code to the first controller is completed.

12. The method as in claim 11, further comprising preventing access the communications bus by the second controller when the first is downloading the set of instruction code.

13. The method as in claim 12, wherein the preventing access step further comprises providing a signal by the first controller to the second controller, the signal holding the second controller in a reset state.

14. The method as in claim 11, further comprising disconnecting the first controller from the communications bus when the downloading of the set of instruction code to the first controller is completed.

15. The method as in claim 11, further comprising disconnecting the first controller from the communications bus by a switching device when the downloading of the set of instruction code to the first controller is completed.

16. The method as in claim 15, wherein the switching device is a Field Effect Transistor (FET) bus switch or a tri-statable buffer.

17. The method as in claim 11, further comprising providing a signal from the second controller to the first controller when the downloading of the set of instruction code to the second controller (204) is completed, the signal connecting the first controller to the communications bus.

18. The method as in claim 11, further comprising providing an initializing signal to reset the first controller to initiate the sequential downloading of the set of instruction code to the first and second controllers.

19. The method as in claim 18, wherein the initializing signal is provided when a supply voltage exceeds a predetermined voltage.

20. An apparatus comprising:
means for storing a set of instruction code used by a plurality of controllers;
means for downloading the set of instruction code to a first controller over a common communications bus; and
means for downloading the set of instruction code to a second controller over the common communications bus when the downloading of the set of instruction code to the first controller is completed.
